(19) United States
(12) Patent Application Publication
(10) Pub. No.: US 2015/0144628 A1
(43) Pub. Date: May 28, 2015

(54) DUAL PURPOSE BEVERAGE LID AND CONDIMENT PALETTE

(71) Applicant: Adam Piper, Fond du Lac, WI (US)

(72) Inventor: Adam Piper, Fond du Lac, WI (US)

(21) Appl. No.: 14/546,037

(22) Filed: Nov. 18, 2014

Related U.S. Application Data
(60) Provisional application No. 61/907,479, filed on Nov. 22, 2013.

(51) Int. Cl. B65D 51/28; B29D 99/00

(52) U.S. Cl. CPC B65D 51/2807; B29D 99/0096
USPC 220/212; 264/239

(57) ABSTRACT

A dual purpose cup lid and condiment vessel device. The device includes a body having a cup engagement interface that is formed proximate a perimeter edge of the body. The cup engagement interface faces in an operating direction associated with engaging the device with a rim of an underlying beverage cup. A condiment reservoir is defined by the body and is disposed radially inboard of the cup engagement interface. The condiment reservoir is defined by a blind hole having a single opening that faces in the operating direction associated with the cup engagement interface such that the device can be used as a cup lid in a first orientation and as a condiment palette when the device is flipped over and otherwise dissociated with a beverage cup.

### CROSS-REFERENCE TO RELATED APPLICATION

This application claims priority to U.S. Provisional Patent Application Ser. No. 61/907,479, filed on Nov. 22, 2013, titled “Recyclable, Plastic Cold-Beverage Lid with Condiment Palette”, the entirety of which is expressly incorporated herein.

### BACKGROUND OF THE INVENTION

The present invention relates generally to molded recyclable beverage lids common in many food service industries. More specifically, the present invention is directed to a molded recyclable plastic cool-beverage lid that is reversible to function as one of a beverage lid or a point of use condiment palette.

Recyclable plastic beverage lids are commonly used in a variety of venues, such as fast food restaurants, cafeterias, stadiums and other special-event venues, gas stations, etc. Such recycle beverage lids are commonly provided in a number of sizes that can each be associated with a rim of a cup that has a similar cross-sectional size and shape as the respective lid. Such lids commonly include at least one partial serration associated with introducing a straw or the like through the lid and into the contents of the underlying cup for consumption of the contents of the cup. Still other lid configurations include at least one serration associated with a movable cover that defines an opening in the lid for consumption of the contents of the cup in a manner more customary to drinking from an uncovered cup or container. Commonly, such cup and lid assemblies are provided as disposable or recycle cups and lids and are commonly associated with use by a single consumer although some users are comfortable sharing the contents of the cup with other users.

Venues associated with providing such cups commonly provide beverages as an accompaniment to food items, such as an entire meal or other discrete foodstuffs such as, pretzels, chicken, hot dogs, French fries, other potato products, onion rings, nachos, etc. It should be appreciated that the listing above is merely exemplary and is not exhaustive or otherwise all inclusive of the foodstuffs provided in such environments as take-and-go food products. Regardless of the particular nature of the food stuffs, many users commonly prefer use of one or more condiments or dipping sauces during consumption of such foodstuffs.

Recognizing the consumer desire for such condiments, many service providers commonly provide single use condiment products, such as ketchup packets, dip containers, etc. to provide a convenient and efficient methodology for consumers to acquire the desired amounts of discrete condiments. Still other food service providers, in an effort to reduce the generation of waste or refuse associated with their services and/or to satisfy consumer price demands, provide such condiments in a bulk point of use configuration wherein the user selects the desired condiment and dispenses a desired amount of the one or more condiments directly to their food products or to ancillary devices, such as discrete cups, or napkins, or other dedicated condiment vessels immediately prior to the consumption activity. Distributing condiments in such manners are not without their respective drawbacks.

Providing consumers with discretely packaged volumes of condiments presents the potential for consumers taking more condiment than is necessary in those instances when returning to the service provider is impractical. Providing the condiment in bulk point of use configurations requires the service provider to maintain various adequate volumes of various disposable devices, such as small cups or the like, associated with the consumer's self-service of available condiments. Food service providers must commonly purchase separate vessels to hold such condiments and sauces to transfer them to the consumer. That is, food stuff businesses that provide condiments in such a manner must order and maintain multiple products to meet the need for covering beverage cups and containing condiments. Such methodologies increase the service provider operating costs, although such costs are commonly conveyed to consumers, and requires additional storage and consumer accessible service space.

Many such condiment containers associated with discrete use from bulk source condiment containers are provided as small cups that are commonly formed of a paper-type material or plastic-type material. When formed of paper-type materials, such discrete containers are susceptible to undesired collapse or failure of the container during transport and/or consumption of foodstuffs. Such paper-type condiment cups also commonly absorb moisture for the condiment thereby limiting the applicability of such condiment cups to lower moisture condiments. Additionally, the absorption of moisture from the condiment associated with use of such paper-type cups can detract from the flavor associated with the condiment.

Further, many such containers are sized such that many consumers, in order to avoid returning to the dispensing location, must acquire, fill, and transport a plurality of individual open faced container vessels. The interaction associated with filling a plurality of discrete condiment vessels can detract from consumer throughput rates causing backups at both condiment and beverage stations in those applications where such stations are sequentially oriented relative to one another. Such considerations can detract from the consumer experience in those environments where the foodstuff providers are associated with limited intermissions environments, such as, cafeteria environments associated with limited lunch breaks, sporting or other events, etc. Further, transporting a plurality of discrete condiment vessels increases the potential for inadvertent spillage, dropping or the like of one or more of the filled discrete containers. Such considerations render such condiment containers ill-suited for use in a variety of environments as well as a variety of condiments customary to various food stuff products.

Still further, and regardless of being provided as a plastic-type or paper-type condiment cup, the commonly constricted open top, and top heavy configuration of such portable point of use condiment containers, can complicate the consumer's transportation or use of such devices. When formed of plastic-type materials, the diameter of the open top commonly limits the introduction of foodstuffs into the container in a manner that can detract from the efficient and economic usage of the condiment contained therein. When formed of a paper-type material, introduction of foodstuffs that are larger than the open end of such condiment cups increases the potential of collapsing the condiment cup and increases the difficultly associated with the consumers simultaneous transportation of a plurality of containers, associated foodstuffs, and beverages. Such considerations are exacerbated when the consumer is simultaneously transporting foodstuffs and beverages from one location to another, or while eating and drinking in venues with no or only limited or fully occupied customer eating surfaces.

Appreciating the short-comings of such condiment dispensing and consumption methodologies, others provide dual purpose beverage lids that are constructed that support a condiment but such prior devices suffer from various other drawbacks. Plastic recyclable cold beverage lids exist in a variety of configurations that permit a user to drink a beverage from a cup without removing the lid, such as via a drink-through feature such as a straw hole, or the like, as disclosed further below. Some such lids also include one or more indicators associated communicating the type of beverage contained within the cup to subsequent handlers and/or a consumer.

Some such prior art lids commonly incorporate a full or partial serration, commonly in the shape of an “X” or “T” that separates a number of flaps joined by the serrations or lines of weakness, such that a straw can be inserted through the lid. Other covers or lids instead have an opening that may be sealed by a depressible tab or the like such that when the tab is depressed, the opening is unsealed for drinking the contents of the container. Such plastic recyclable cold beverage lids are commonly single-use or single consumer devices associated with covering a cold beverage cup.

U.S. Pat. Nos. 6,932,231 and 5,722,558 and U.S. Patent Application Publication No. 2004/0182862 disclose various disposable lid configurations wherein each discrete lid is configured to accommodate usage of a condiment with either of the contents of an underlying cup and/or other foodstuffs. Unfortunately, such lids are not without their respective drawbacks. U.S. Pat. No. 5,722,558 discloses a drink lid with a condiment reservoir wherein the reservoir is associated with the exterior facing side of the lid when the lid is associated with a cup. Such a configuration exposes the user to the condiment during drinking activities, places the condiment in close proximity to the drinking activity, and limits use of the lid as a horizontally oriented condiment container only after the lid has been associated with an underlying cup. That is, the non-central orientation and the relatively large depth of the offset associated with defining the condiment reservoir renders the lid incapable of maintaining a generally horizontal orientation when associated with a condiment or discrete condiment container and not otherwise associated with an underlying cup.

U.S. Patent Application Publication No. 2004/0182862 discloses a lid similar to that disclosed in the '558 patent but discloses a lid having a generally shallow reservoir that is constructed to accommodate discrete packages of condiment as shown in FIG. 3 of the '862 publication. Such a configuration limits the ability of the venue or service provider to appreciate the economies and efficiencies associated with providing condiments to a consumer from bulk source materials. The lid disclosed in the '862 publication also leaves the exposed condiment in close proximity to the drinking activity and leaves the user exposed to any condiments associated therewith during each drinking activity. The assembly further presents the potential of a discrete condiment container from being inadvertently dislodged from the lid increasing the potential for spills or the like.

U.S. Pat. No. 6,932,231 discloses a beverage cup lid with a condiment addition well. Like the '558 and the '862 publication, the lid disclosed in the '231 patent includes a recess formed in the cover that is exposed to the environment during use of the lid to cover a cup. The lid disclosed in the '231 patent includes a passage that is formed in the recess and extends through the lid into the volume enclosed by the cup and lid association. Such a construction renders the lid unsuitable for supporting condiments that are otherwise not associated or intended to be added to the contents of an underlying cup.

Therefore, there is a need for a dual-purpose cup lid and condiment vessel that can mitigate spillage of the contents of a cup and which can accommodate usage of bulk source foodstuff condiments in a manner that is convenient and economical for both the service provider and the consumer. There is a further need for a dual-purpose beverage lid and condiment support device that improves the user's ability to access all of the acquired condiment and which provides some degree of separation or isolation between the condiment and those areas that surround the device to improve the cleanliness associated with use of the device as a condiment palette.

### SUMMARY OF THE INVENTION

The present invention is directed to a system and method of providing a dual purpose disposable cup lid and condiment vessel device. The device includes a body having a cup engagement interface that is formed proximate a perimeter edge of the body. The cup engagement interface faces in an operating direction associated with engaging the device with a rim of an underlying disposable beverage cup. A condiment reservoir is defined by the body and is disposed radially inboard of the cup engagement interface. The condiment reservoir is defined by a blind hole having a single opening that faces in the operating direction associated with the cup engagement interface such that the device can be used as a cup lid in a first orientation and as a condiment palette when the device is flipped, over and otherwise dissociated with a beverage cup.

Another aspect of the invention that is usable with one or more of the features of aspects above discloses a dual purpose disposable cup lid and condiment vessel device defined by a unitary body. The body extends in a lateral direction and is bounded by a perimeter to define a first side that faces in an upward direction relative to the lateral direction and a second side that faces in a downward direction that is opposite the upward direction relative to the lateral direction. A channel is disposed about the perimeter of the body and is shaped to removably cooperate with a rim of a disposable cup such that the second side of the body faces a volume defined by the disposable cup when the body is engaged therewith. At least one condiment reservoir in the shape of a blind hole is defined by the body. The blind hole is defined by an opening that is radially inboard of the channel and such that the opening of the condiment reservoir is accessible from the second side of the body.

A further aspect of the invention that is usable or combinable with one or more of the above features and aspects discloses a dual purpose single use cup lid condiment vessel system. The system includes a body and a cup engagement interface that is defined by and formed about a perimeter of the body. The cup engagement interface is constructed to removably secure the body to a rim of a cup. A condiment reservoir is defined by a blind hole formed in the body. The blind hole is defined by a bottom and an upstanding wall that terminates to define a single opening of the blind hole. The single opening is oriented to face the same direction as the cup engagement interface.

Another aspect of the invention that is usable or combinable with one or more of the above features or aspects discloses a method of forming a disposable dual purpose cup lid and condiment container device. The method includes forming a lid that is shaped to removably cooperate with a disposable beverage cup to define a top side of the lid that faces atmosphere and a bottom side of the lid that faces a volume of a disposable beverage cup when the lid is engaged with a disposable cup. The lid is further shaped during formation to define a condiment reservoir formed by a blind hole having a single opening such that the blind hole is radially offset from a cup engagement interface defined by the lid and such that the single opening is accessible from the bottom side of the lid.

These and other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is a perspective view of a dual purpose lid and condiment palette device according to one embodiment of the invention associated with a disposable cold beverage cup;

FIG. 2 is perspective view of an underside of the device shown in FIG. 1;

FIGS. 3 and 4 are views similar to FIG. 2 of the device shown in FIG. 1 with a condiment and a foodstuff associated therewith during use of the device as a condiment palette;

FIG. 5 is a top plan view of a dual purpose cup lid and condiment palette device according to another embodiment of the invention;

FIG. 6 is a view similar to FIG. 7 of a disposable cup associated with a dual purpose cup lid and condiment palette device according to another embodiment of the invention; and

FIG. 7 is a cross-sectional view of the device shown in FIG. 6 taken along line 7-7.

The following detailed description discloses the best mode contemplated for carrying out the invention. The description is not to be taken in a limiting sense, but is made merely for the purpose of illustrating the general principles of the invention.

### DETAILED DESCRIPTION OF THE PREFERRED EMBODIMENTS

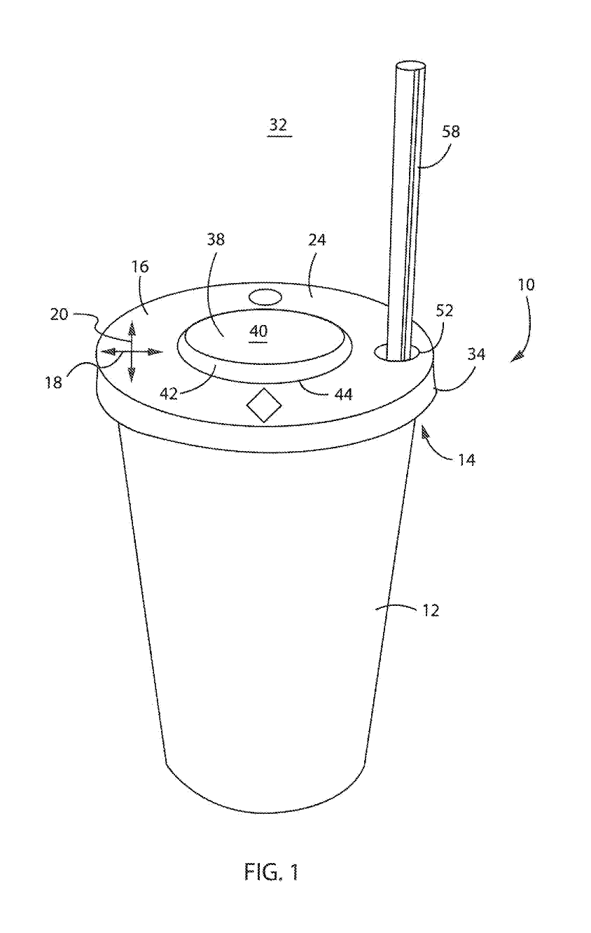

FIG. 1 shows a dual purpose cup lid and condiment palette system or device 10 according to a first embodiment of the present invention which is engaged with a disposable recyclable customarily single-use cool beverage cup 12. Device 10 and cup 12 can be formed of numerous materials but are customarily formed of paper-type and/or plastic-type materials. It is further appreciated that device 10 can be provided in various sizes and shapes to accommodate usage of the device with disposable cups 12 of various types and sizes, especially with those cups commonly used as carry-out containers for cold beverages such water, soda, iced tea, smoothies, etc. As is commonly understood, such cups 12 typically have a circular upper lip or rim 14 that will removably but sealing cooperate with dual purpose device 10.

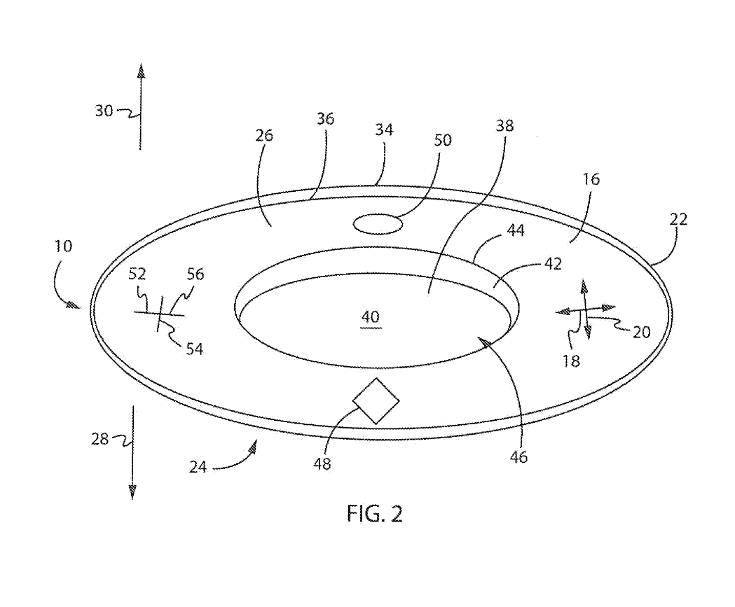

Dual purpose device 10 is generally defined by a continuous unitary body 16 that, when oriented in a first orientation as shown in FIG. 1, snap-fittingly cooperates with cup 12. Referring to FIGS. 1 and 2, body 16 of dual-purpose device 10 extends in a generally lateral planar manner, indicated by arrows 18, 20, that is bounded by a perimeter edge 22 of body 16. Body 16 defines a top, upward, atmosphere facing, or first side 24 and a downward, cup facing, or second side 26. Sides 24, 26 face in generally opposite directions, indicated by arrows 28, 30, relative to the generally planar shape of device 10 as defined by the laterally oriented directions 18, 20 associated with body 16. When engaged with cup 12, first side 24 of body 16 is exposed to atmosphere 32 and body 16 is engaged with cup 12 to prevent spillage of the contents associated therewith. As should be appreciated, when body 16 is engaged with cup 12, second side 26 of body 16 is directed toward the volume generally enclosed by cup 12.

A lip 34 extends about perimeter edge 22 of body 16 and defines a channel 36 that is shaped to removably cooperate with rim 14 of cup 12. Preferably, the cooperation between dual purpose device 10 and cup 12 is secure enough to prevent undesired or unintended separation therebetween but is operable to allow the user to manually remove device 10 from cup 12 for refilling of cup 12 and/or for inspection of the contents of the underlying cup. It is appreciated that the cooperation between device 10 and rim 14 of cup 12 may have a continuous cross-sectional shape about perimeter edge 22 or may be configured to provide a plurality of radially spaced interfaces associated with securing device 10 relative to cup 12 when device 10 is utilized as a cup lid. It is appreciated that such constructions provide device 10 with a cup engagement interface that allows device 10 to securely cooperate with an underlying cup and to do so in a selectively removable manner.

Body 16 is shaped to define a condiment vessel or reservoir 38 that is defined by a bottom 40 and one or more upstanding walls 42 that extend in a crossing direction relative to bottom 40 of reservoir 38. Upstanding wall 42 terminates had an edge 44 that is offset from bottom 40 and defines an opening 46. The cooperation of bottom 40 and wall 42 defines reservoir 38 as a blind hole or a hole having a single inlet and outlet opening. Reservoir 38 is radially offset from perimeter edge 22 of body 16 and defined by a depth that extends in a crossing direction relative to lateral directions 18, 20 associated there with. Opening 46 associated with reservoir 38 faces direction 30 or a direction associated with facing the contents of cup 12 when dual-purpose device 10 is used as a cup lid or cover. Said in another way, device 10 is reversible or can be flipped from a first orientation wherein device 10 can be used a cup lid and a second orientation wherein device 10 can be utilized to support a volume of a condiment in a readily transportable and sanitary manner and in a manner that accommodates containment of the condiment during consumption of the same.

Body 16 includes one or more beverage indicators 48, 50 and a drink-through aperture 52 formed between edge 44 and perimeter edge 22. Drink indicators 48, 50 are depressible in direction 30 from top side 24 so as to provide an indication of the contents of a cup associated with use of device 10 as a beverage lid. Drink through aperture 52 includes an opening or one or more selectively separable serrations 54, 56 formed in body 16 to accommodate passage of a drinking device, such as a straw 58, through body 16 when dual purpose device 10 is utilized as a cup lid.

Drink-through aperture 52 is disposed between edge 44 associated with condiment reservoir 38 and perimeter edge 22 of body 16. Such a consideration reduces the potential of condiment passing through body 16 when device 10 is utilized as a condiment palette. It is further appreciated that bottom 40 associated with condiment reservoir 38 could also include one or more depressed drink symbol indicators, such as indicators 48, 50, as such features are commonly generally continuous relative to body 16 such that utilization of such features do not ordinary result in a perforation through body 16. The selectively severable opening associated with drink-through aperture 52 is preferably disposed between edge 44 of condiment reservoir 38 and perimeter edge 22 of body 16 so as to prevent passage of condiment introduced to reservoir 38 through body 16. It is however appreciated that were drink-through aperture provided as a selectively sealed and severable feature, such a drink-through aperture could be associated with reservoir 38 as device 10 is usable at any given time as only one of a drink lid or a condiment vessel as the accessible opening associated with the vessel faces the same side of device 10 as operational direction associated with the cup engagement interface.

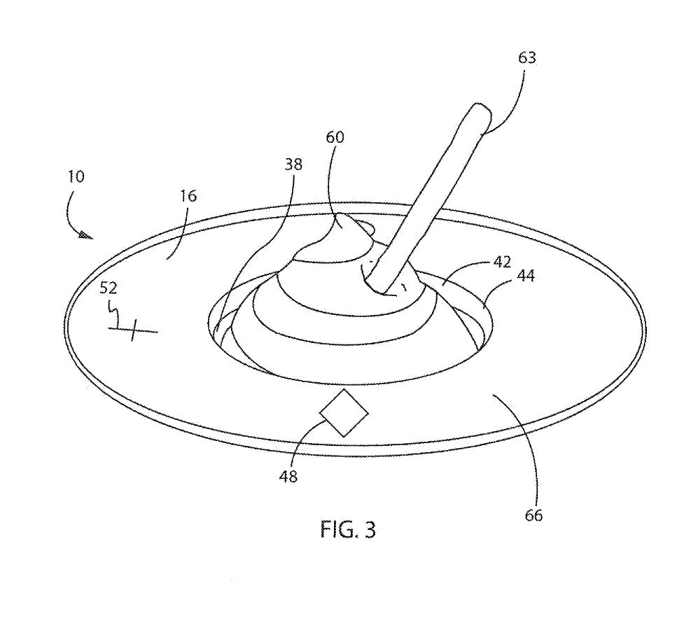

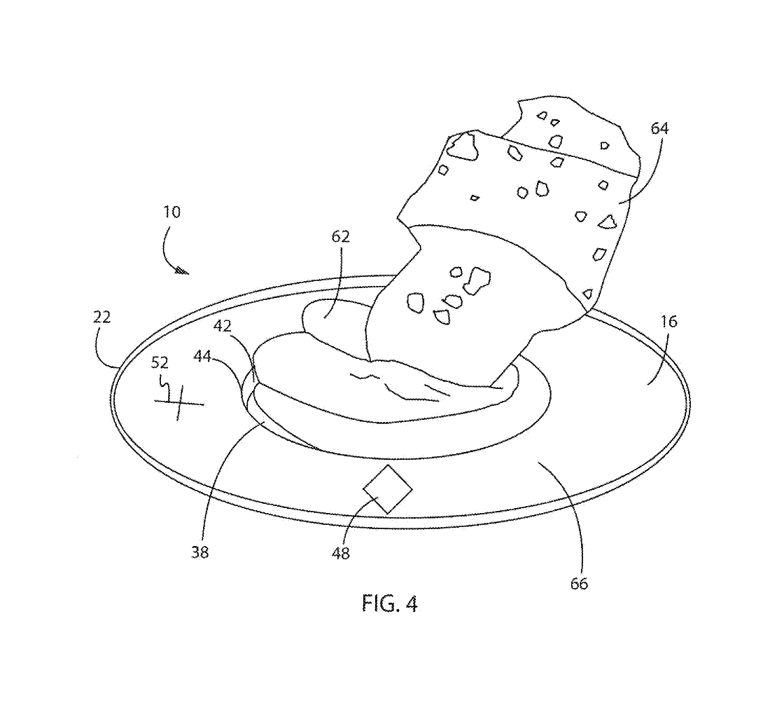

FIGS. 3 and 4 show dual-purpose device 10 having respective condiments 60, 62 associated with condiment reservoir 38 and foodstuffs, such as a French fry 63 or other food product 64, such as chicken, fish, bread or potato products, for example, engaged with the respective condiments 60, 62. As shown in FIGS. 3 and 4, condiments 60, 62 with sufficient viscosity can extend above end or edge 44 associated with condiment reservoir 38.

A portion 66 of body 16 defines a palette portion of dual purpose device 10 which extends between edge 44 of condiment reservoir 38 and perimeter edge 22 of body 16. Portion 66 mitigates passage of condiment 60, 62 out of engagement with device 10 and can provide a visual indication to the user to reorient device 10 to maintain the integrity of association of condiment 60, 62 with device 10. Portion 66 allows dual purpose device 10 to provide a palette or generally enlarged area associated with supporting respective condiments 60, 62 when dual-purpose device 10 is utilized as a condiment vessel or condiment transport and/or support device. Such a consideration improves the cleanliness associated with the transport, use, and consumption associated with foodstuffs 63, 64 and respective condiments 60, 62. Further, portion 66 of dual-purpose device 10 provides an area wherein the user can remove excess condiment 60, 62 that may have been inadvertently associated with foodstuffs 63, 64 and in a manner wherein the integrity of the condiment for future use is not compromised.

Further, the somewhat flexible nature of body 16 allows deflection of dual-purpose device 10 during transport and/or use of the same. For instance, device 10 would fit comfortably within the palm of the hand of a user and be slightly compressible so as to provide a positive interaction between the user's hand and device 10 without unduly interfering and/or displacing condiments 60, 62 relative thereto. Further, for some foodstuffs that include openings or the like, such as pretzels, it is envisioned that device 10 with a condiment 60, 62 associated therewith can slidably cooperate with an opening defined by the shape of the foodstuff, such as a loop of a pretzel, and in a manner wherein the temporarily deformed shape of device 10 maintains a secure cooperation between the device and the foodstuff during transport of the same.

Device 10 provides a dual purpose cup lid and condiment support device that is particularly useful for those environments wherein condiments are not otherwise provided in discrete use packages or containers that can otherwise be placed in a pocket or the like and/or are otherwise dispensed only from bulk condiment sources at locations proximate the purchase activity. When used a cup lid, device 10 provides a secured generally sealed cover of the contents of the cup and when used as a condiment palette, device 10 allows the consumer to acquire just a desired or necessary amount of a condiment and conveniently transportable platform. Further, service providers are not required to expend the cost, efforts, and service associated with maintaining a first device for covering drink cups and a second device for providing condiments to consumers.

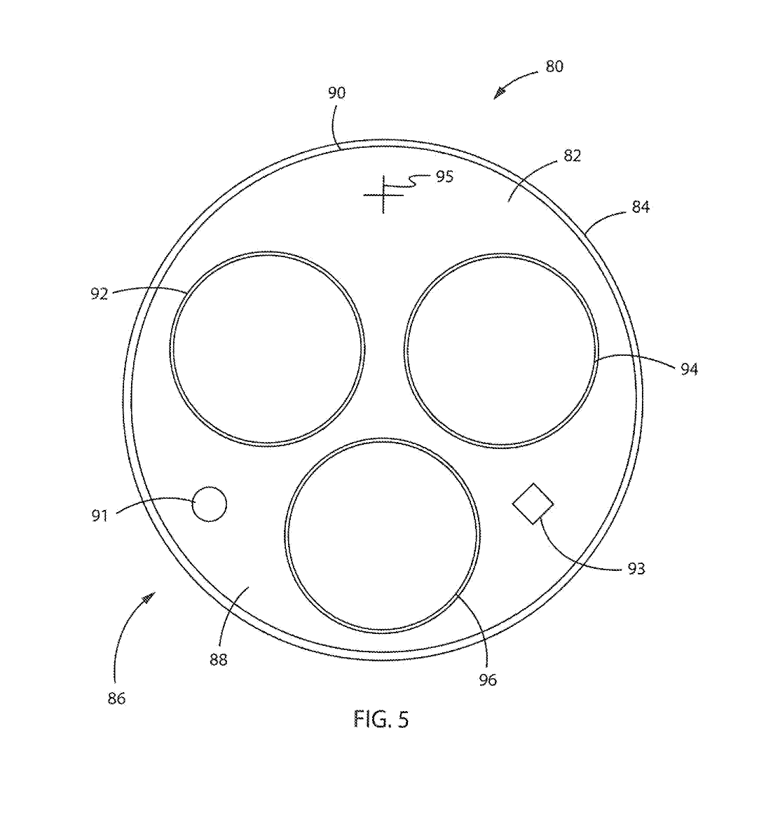

FIG. 5 shows a dual-purpose device 80 according to another embodiment of the invention. Like device 10, device 80 includes a body 82 that extends in a generally planar direction within a boundary defined by a perimeter 84 of the body 82. Device 80 includes a first side 86 that is oriented to face atmosphere when device 80 is engaged with a disposable drink cup and a second side 88 that is configured to face the contents of such a cup when device 80 is used in such a manner. A cup engagement interface 90 is formed proximate perimeter 84 such that device 80 snap-fittingly and sealingly cooperates with an underlying cup when used in such a manner.

Body 82 includes one or more compressible drink indicators 91, 93 as well as a drink-through aperture 95 associated with accommodating passage of a straw through body 82. Unlike dual-purpose device 10, dual-purpose device 80 includes a plurality of condiment reservoirs 92, 94, 96 that are each defined by body 82 and disposed radially inboard of perimeter 84. Each condiment reservoir 92, 94, 96 is defined as a blind hole having a single opening that faces a second side 88 of body 82 which would be exposed to the contents of a cup when device 80 is used as a cup lid. The plurality of condiment reservoirs 92, 94, 96 allows a single device 80 to transport multiple condiments in a secure and sanitary manner and in a manner that preferably maintains separation between the respective condiments. It is appreciated that the plurality of reservoirs 92, 94, 96 could be provided in various shapes and configurations and/or alternate depths so as to accommodate various different amounts of condiment with a single device. Further, although three condiment reservoirs are shown, it is further appreciated that devices 10, 80 can each be provided with other numbers of condiment reservoirs, such as two or four, for example.

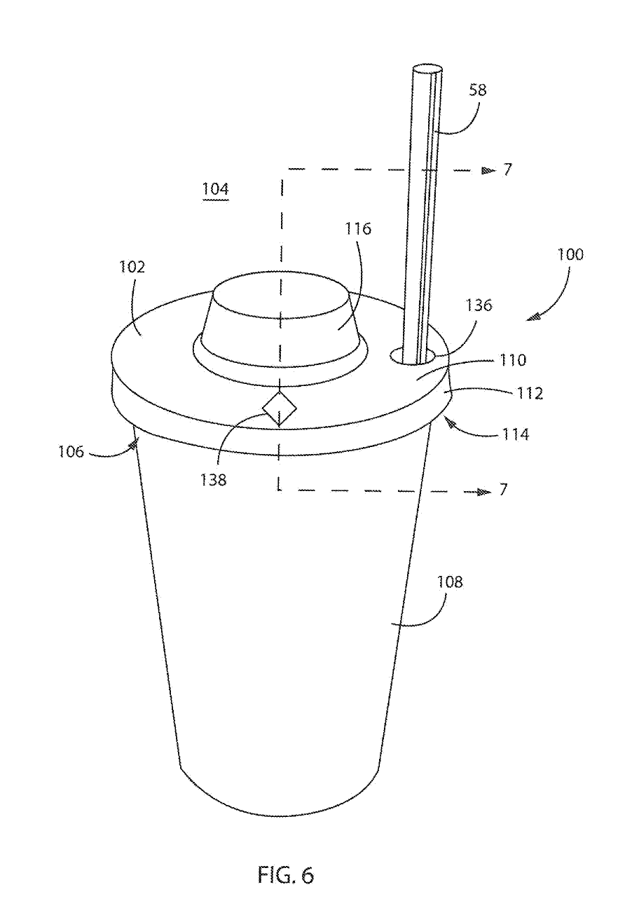

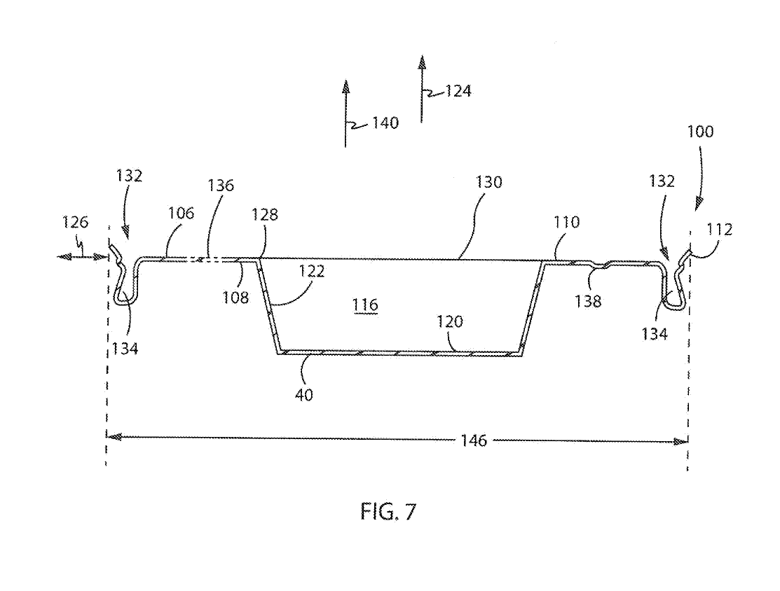

FIGS. 6 and 7 show a dual-purpose device 100 according to another embodiment of the invention. Like devices 16, 80, device 100 includes a first side 102 that faces atmosphere 104 and the second side 106 that faces the contents of a disposable cup 108 during utilization of device 100 as a cup lid constructed to removably cooperate with cup 108. Device 100 is defined by a generally unitary body 110 bounded by a perimeter 112 that snap fittingly cooperates with a rim 114 of cup 108.

Body 110 defines a condiment reservoir 116 that is disposed with in perimeter 112 of body 110. Reservoir 116 is defined by a bottom 120 and an upstanding wall 122 that extends in a crossing direction, indicated by arrow 124, relative to a plane, indicated by arrow 126 (FIG. 7), defined by the remainder of body 110 or that portion of body 110 that is offset from the blind hole that defines condiment reservoir 116.

Upstanding wall 122 includes an edge or end 128 such that condiment reservoir 116 is formed as a blind hole defined by a single opening 130 that faces second side 106 of body 110. Opening 130 is radially offset from perimeter 112 and is oriented radially inboard relative to a cup engagement interface 132 that extends circumferentially about body 110. As shown in FIG. 7, cup engagement interface 132 is shown generally as a channel 134 defined by body 110 and which is shaped to snap-fittingly cooperate with a rim of an underlying cup 108 when device 100 is used as a cup lid. Device 100 also includes a drink-through aperture 136 configured to allow passage of drink mechanism, such as straw 58, through body 110. Device 100 also includes one or more drink indicators 138 that are selectively depressible so as to provide an indication as to the contents associated with an underlying cup 108 when device 100 is utilized as a cup lid.

Referring to FIG. 7, it is further appreciated that condiment reservoir 116 is generally deeper, indicated by direction 124, than condiment reservoirs 38, 92, 94, 96. It is appreciated that reservoir 116 can be configured to receive any number of volumes of condiment such as an ounce, 1.5 ounces, etc. It is further appreciated that devices 10, 80, 100 can include signage associated with the volume of the respective reservoir for those users interested in such information for dietary purposes. Although end 128 associated with opening 130 of condiment reservoir 116 is shown as being generally coterminous with plane 126 of body 110, it is further appreciated that end 128 can be displaced in direction 140 relative to the plane 126 such that end 128 associated with walls 122 would be generally proud of second side 106 of body 110. It is further appreciated that the bottom associated with condiment reservoir 116 could be oriented to be generally coplanar with plane 126 or generally nearer thereto than is shown in FIG. 7.

Preferably, each of dual purposes devices 10, 80, 100 is constructed to be stackable and/or nest-able such that adjacent devices are maintained in relatively close proximity to one another so as to provide a substantially compact orientation of multiple devices. Such a consideration reduces the space requirements associated with maintaining and/or dispensing a plurality of dual-purpose devices 10, 80, 100 and in a manner wherein discrete devices are readily separable from one another to facilitate convenient usage of the same by users such as service personnel and/or the consumer.

It is further appreciated that the generally planar shape associated with the bottoms 40 associated with the condiment reservoirs 38, 92, 94, 96, 116 provide a fairly robust support for cooperation of the respective device when utilized as a condiment palette. Each of devices 10, 80, 100 including an area that generally circumscribes the opening associated with the respective condiment reservoir(s) to maintain a sanitary condition associated with transport and consumption of the condiments. The area generally surrounding the respective condiment reservoirs also provides a sanitary and robust structure that is suitable to accommodate the removal of excess condiment which may be inadvertently introduced to the desired foodstuffs.

Further, the generally enlarged footprint, indicated by dimension 146 (FIG. 7) associated with each of devices 10, 80, 100 when utilized as a condiment vessel mitigates spillage associated with the user's interaction with the respective device and the condiment contained therein. These “palette” portions of the respective devices and particularly advantageous when the respective devices are utilized with less viscous condiments. The cup facing utilization of the respective devices as condiment vessels further allows utilization of the cup engagement interfaces as an impediment to any condiment escaping the area bounded by the perimeter of the respective device. The is, the cup engagement interface functions to capture condiment that may escape the respective reservoir and/or be disposed on those portions of respective devices 10, 80, 100 that are radially outboard of the opening associated with the blind hole which defines the respective condiment reservoir. Such a consideration further enhances the likelihood of a user's sanitary interaction with the device when utilized as a condiment transport, support, and/or consumption device.

When used as a cup lid or cover, each of devices 10, 80, 100 enables a consumer to drink a beverage from the cup in a manner that mitigates spillage of the beverage and can provide an indicator as to the type of beverage contained in the underlying cup. When used as a condiment supporting device or palette, each of devices 10, 80, 100 allow a consumer to neatly place, transport, and consume with a paired food item, any condiment or sauce, as well as apply and partially remove excess condiment to and from the respective food item. Each of devices 10, 80, 100 are configured to allow service providers to maintain a bulk source of devices that can be usable as one of a drink lid and a condiment vessel in a compact form factor wherein the discrete devices can be incrementally separated from one another during use as either of a drink lid or a condiment vessel.

Different embodiments of the dual purpose cup lid and condiment vessel may include one or multiple cavities or wells associated with containing a volume of a condiment. Preferably, each condiment vessel is bounded by a portion of the body associated with defining the device to accommodate mixing and/or removal of condiments from foodstuffs and to prevent spillage of the condiment beyond the area bounded by the perimeter edge of the respective device.

Therefore, one embodiment of the invention includes a dual purpose disposable cup lid and condiment vessel device that is defined by a unitary body. The body extends in a lateral direction and is bounded by a perimeter to define a first side that faces in an upward direction relative to the lateral direction and a second side that faces in a downward direction that is opposite the upward direction relative to the lateral direction. A channel is disposed about the perimeter of the body and is shaped to removably cooperate with a rim of a disposable cup such that the second side of the body faces a volume defined by the disposable cup when the body is engaged therewith. At least one condiment reservoir in the shape of a blind hole is defined by the body. The blind hole is defined by an opening that is radially inboard of the channel and such that the opening of the condiment reservoir is accessible from the second side of the body.

Another embodiment of the invention includes a dual purpose single use cup lid condiment vessel system. The system includes a body and a cup engagement interface that is defined by and formed about a perimeter of the body. The cup engagement interface is constructed to removably secure the body to a rim of a cup. A condiment reservoir is defined by a blind hole formed in the body. The blind hole is defined by a bottom and an upstanding wall that terminates to define a single opening of the blind hole. The single opening is oriented to face the same direction as the cup engagement interface so that the volume associated with the condiment reservoir is isolated from atmosphere when the body is utilized as a cup lid.

A further embodiment of the invention includes a method of forming a disposable dual purpose cup lid and condiment container device. The method includes forming a lid that is shaped to removably cooperate with a disposable beverage cup to define a top side of the lid that faces atmosphere and a bottom side of the lid that faces a volume of a disposable beverage cup when the lid is engaged with a disposable cup. The lid is further shaped during formation to define a condiment reservoir formed by a blind hole having a single opening such that the blind hole is radially offset from a cup engagement interface defined by the lid and such that the single opening is accessible from the bottom side of the lid.

Many changes and modifications could be made to the invention without departing from the spirit thereof. The scope of these changes will become apparent from the appended claims.

1. A dual purpose disposable cup lid and condiment vessel device, the device comprising:
a body that extends in a lateral direction and is bounded by a perimeter to define a first side that faces in an upward direction relative to the lateral direction and a second side that faces in a downward direction that is opposite the upward direction relative to the lateral direction;
a channel disposed about the perimeter of the body and shaped to removably cooperate with a rim of a disposable cup so the second side of the body faces a volume defined by the disposable cup when the body is engaged therewith; and
at least one condiment reservoir defined by a blind hole having an generally circular opening that is radially inboard of the channel and such that the generally circular opening of the condiment reservoir is accessible from the second side of the body.

2. The device of claim 1 wherein the condiment reservoir further comprises a lip that extends about the blind hole and is proud of the second side of the body.

3. The device of claim 1 wherein the body further comprises at least one beverage indicator that is depressible from the first side of the body.

4. The device of claim 3 wherein the at least one beverage indicator is disposed between the condiment reservoir and the channel.

5. The device of claim 4 further comprising at least one drink-through aperture for selectively passing a straw through the body.

6. The device of claim 1 further comprising a plurality of generally circular condiment reservoirs.

7. The device of claim 1 further comprising a plurality of dual purpose cup lid and condiment vessel devices and the plurality of dual purpose cup lid and condiment vessel devices are nestable.

8. A dual purpose single use cup lid condiment vessel system, the system comprising:
a body;
a cup engagement interface defined by and formed about a perimeter of the body, the cup engagement interface constructed to removably secure the body to a rim of a cup; and
a condiment reservoir defined by a blind hole formed in the body, the blind hole defined by a bottom and an upstanding wall wherein the upstanding wall terminates to define a single opening of the blind hole and the single opening faces the same direction as the cup engagement interface, the bottom of the hole having a smaller cross-sectional footprint area that is less than a cross-sectional footprint area of the single opening.

9. The system of claim 8 wherein the cup engagement interface is contained in a plane defined by the body.

10. The system of claim 9 wherein termination of the upstanding wall and the bottom of the condiment reservoir are on opposite sides of the plane.

11. The system of claim 9 wherein one of the bottom and termination of the upstanding wall of the condiment reservoir are nearer the plane than the other bottom and termination of the upstanding wall.

12. The system of claim 8 further comprising a drink-through aperture formed in the body and that is radially offset from the condiment reservoir.

13. The system of claim 8 further comprising another condiment reservoir that is fluidly isolated from the condiment reservoir and which includes a single opening that faces in the same direction as the single opening the condiment reservoir.

14. The system of claim 8 further comprising at least one depressible beverage indicator.

15. The system of claim 14 wherein the at least one depressible beverage indicator is formed by the body and is offset from the condiment reservoir.

16. A method of forming a disposable dual purpose cup lid and condiment container device, the method comprising:
forming a lid that is shaped to removably cooperate with a disposable beverage cup to define a top side of the lid that faces atmosphere and a bottom side that faces a volume of a disposable beverage cup when the lid is engaged with a disposable cup; and
shaping the lid during forming to define a condiment reservoir formed by a blind hole having a single opening such that the blind hole is radially offset from a cup engagement interface defined by the lid and the single opening is accessible from the bottom side of the lid; and
forming the lid to be nestable with similarly shaped lids.

17. The method of claim 16 further comprising forming a drink-through aperture in the lid at a location that is offset from the condiment reservoir.

18. The method of claim 16 further comprising forming at least one drink indicator in the lid that is depressible from the top side of the lid.

19. The method of claim 16 further comprising forming the lid to define a plurality of condiment reservoirs.

20. The method of claim 16 further comprising forming a lip along a perimeter of the lid that is shaped to snap-fittingly sealing cooperate with a rim of a disposable cup.
